(19) United States
(12) Patent Application Publication
(10) Pub. No.: US 2013/0226834 A1
(43) Pub. Date: Aug. 29, 2013

(54) SYSTEMS AND METHODS FOR DETERMINING THE FINANCIAL STATUS OF BONDS

(71) Applicant: NetWorth Services, Inc., (US)

(72) Inventor: David W. Gannalo, II, Paradise Valley, AZ (US)

(21) Appl. No.: 13/852,930

(22) Filed: Mar. 28, 2013

Related U.S. Application Data
(63) Continuation-in-part of application No. 12/505,418, filed on Jul. 17, 2009.
Application No. 12/505,418 is a continuation of application No. 09/844,198, filed on Apr. 27, 2001, now Pat. No. 7,606,753.
(60) Provisional application No. 61/616,640, filed on Mar. 28, 2012.
(60) Provisional application No. 60/200,088, filed on Apr. 27, 2000.

(51) Int. Cl. G06Q 40/06

(52) U.S. Cl. CPC G06Q 40/06
USPC 705/36 R

(57) ABSTRACT

Systems and methods for determining the financial status of a bond according to various aspects of the present invention may comprise a graphical user interface, a database linked to the graphical user interface, a bond analysis engine linked to the database, and a display. The graphical user interface may be configured to receive information associated with the bond from the user. The database may be linked to the graphical user interface and configured to store information associated with the bond from the user and retrieve the information associated with the bond from a data repository. The bond analysis engine may be linked to the database and configured to calculate a cost basis. The display may be configured to present the cost basis to the user.

### CROSS-REFERENCE TO RELATED APPLICATIONS

This application claims the benefit of and priority to Provisional Patent Application Ser. No. 61/616,640, entitled SYSTEMS AND METHODS FOR DETERMINING THE FINANCIAL STATUS OF BONDS, filed on Mar. 28, 2012 and this application is a continuation-in-part of U.S. patent application Ser. No. 12/505,418, filed Jul. 17, 2009, which is a continuation of U.S. patent application Ser. No. 09/844,198, filed Apr. 27, 2001, now U.S. Pat. No. 7,606,753, which claims the benefit of and priority to Provisional Patent Application Ser. No. 60/200,088, filed Apr. 27, 2000, and incorporates the disclosure of such applications by reference. To the extent that the present disclosure conflicts with any referenced application, however, the present disclosure is to he given priority

### BACKGROUND OF THE INVENTION

Determining the financial characteristics of a bond requires consideration of information from many sources and knowledge of various accounting methods and strategies. A bondholder may need to determine the cost basis of the bond, the adjusted cost basis, gains and losses in value, interest rates and payments, yield to maturity, and many other types of financial information. This information may be necessary to properly inform a number of financial practices such as preparing taxes, evaluating investment portfolios, and reconciling business records.

One important financial aspect of a bond is the tax consequences from selling the bond. The tax basis of the sale determines the tax consequences. Typically, the tax to be paid on the sale may be for the gain in value of the investment. However, the loss in value of the investment may also have tax advantages, such as reducing tax owed by an individual. The gain or loss may comprise the difference between the adjusted cost basis of the bond and the current market value that may result from the sale. The cost basis may consider information such as the face value of the bond, sales commissions, and/or adjustments to the cost basis such as amortization of market discounts or bond premiums.

Evaluating various financial characteristics of bonds may be a complicated and time consuming process. Researching historical prices, coupon rates, and current market values in addition to calculating different types of amortization, interest payments, interest amounts at various times during the term of the bond, adjusted cost basis, and/or tax basis may require many hours of investigation, calculation, and analysis of investment portfolios comprising numerous securities. This process may be burdensome, resulting, in high costs and delays in presenting the holder of those securities with options for achieving their financial goals.

### SUMMARY OF INVENTION

Systems and methods for determining the financial status of a bond according to various aspects of the present invention may comprise a graphical user interface, a database linked to the graphical user interface, a bond analysis engine linked to the database, and a display. The graphical user interface may be configured to receive information associated with the bond from the user. The database may be linked to the graphical user interface and configured to store information associated with the bond from the user and retrieve the information associated with the bond from a data repository. The bond analysis engine may be linked to the database and configured to calculate a cost basis and cost basis. The display may be configured to present the cost basis to the user.

### BRIEF DESCRIPTION OF THE DRAWINGS

A more complete understanding of the present invention may be derived by referring to the detailed description when considered in connection with the following illustrative figures. In the following figures, like reference numbers refer to similar elements and steps throughout the figures.

FIG. 1 is a block, diagram representatively illustrating, a bond system in accordance with an exemplary embodiment of the present invention;

FIG. 2 depicts a screen shot of a graphical user interface module that may be accessed by a user in accordance with an exemplary embodiment of the present invention; and

FIG. 3 is a flow chart illustrating a method of operation of a representative implementation of the bond system by a user.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DETAILED DESCRIPTION OF EXEMPLARY EMBODIMENTS

The present invention may be described in terms of functional block components and various processing steps. Such functional blocks may be realized by any number of components configured to perform the specified functions and achieve the various results. For example, the present invention may employ various process steps, apparatus, systems, methods, etc. In addition, the present invention may be practiced in conjunction with any number of systems and methods for providing a computer-implemented system and method for determining the financial status of a bond and the system described is merely one exemplary application for the invention. Further, the present invention may employ any number of conventional techniques for acquiring bond information, determining gain and/or loss in the sale of the bond, determining cost basis of the bond, amortizing bond discounts, accreting bond premiums, calculating interest, calculating yield to maturity, determining the dates of purchase and/or sales of the bond, and/or determining the price of the bond at a preselected date. For example, the present in canon may employ systems, technologies, devices, designs, services and the like, which may carry out a variety of functions. In addition, the present invention may be practiced in conjunction with any number of websites, software applications, information systems, communication systems, data storage systems, and computing devices such as servers, computer databases, personal computers, portable computing devices, smart phones, tablet computers, and the like, and the systems and methods described are merely exemplary applications for the invention.

The particular implementations shown and described are illustrative of the invention and its best mode and are not intended to otherwise limit the scope of the present invention in an way. Indeed, for the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

Various representative implementations of the present invention may be applied to any system for determining the financial characteristics of a bond. Certain representative implementations may also comprise a system such as a graphical user interface that may comprise a website interface and/or may be communicatively coupled to a database for storing, updating, exchanging, analyzing, processing, communicating, and/or displaying the acquired information relating to the bond.

Software and/or software elements according to various aspects of the present invention may he implemented with any programming or scripting language, such as, for example, C, C++, Java, COBOL, assembler, PERE, eXtensible Markup Language (XML), PHP, etc. or any other programming and/or scripting language, whether now known or hereafter described in the art.

Various representative algorithms may he implemented with any combination of data structures, objects, processes, routines and/or other programming elements. Further, the present invention may employ any number of conventional techniques for data transmission, signaling, data processing, network control, and/or the like. Applications according to various aspects of the present invention may be formulated and a network may be provided that may include any system for exchanging data, such as, for example, the Internet, an intranet, an extranet, WAN, LAN, satellite communications, and/or the like. The network may be implemented as other types of networks, such as an interactive television (ITV) network. The users may interact with the system by any input device such as a keyboard, mouse, kiosk, personal digital assistant, handheld computer, cellular phone such as a Smartphone that may have access to the internet, text messaging by cellular phone and/or the like. Similarly, the invention may be used in conjunction with any type of personal computer, network computer, workstation, minicomputer, mainframe, or the like running any operation system such as any version of Windows, Windows XP, Windows Longhorn, Windows Whistler, Windows ME, Windows Mobile, Windows NT, Windows 2000, Windows Server, Windows 98, Windows 95, Windows Vista, Windows 7, MacOS, OS/2, BeOS, Linux, UNIX, or any other operating system, whether now known or hereafter. Moreover, the invention may be implemented with TCP/IP communications, IPX, AppleTalk, IP-6, NetBIOS, OSI or any number of existing or future protocols. Moreover, the system may comprise the use, sale and/or distribution of all goods, services and/or information having similar functionality described herein.

The system elements may be connected by a data communication network. The network may be a public network and assumed to be insecure and open to eavesdroppers. In one exemplary implementation, the network may be embodied as the Internet. In this context, computers may or may not be connected to the Internet at all times.

A variety of conventional communications media and protocol may be used for data links, such as a connection to an Internet Service Provider (ISP) over a local loop as is typically used in connection with standard modem communication, wireless cellular communication, cable modem, satellite television providers, Integrated Service Digital Network (ISDN), Digital Subscriber Line (DSL), and/or various wireless communication methods. Polymorph code systems might also reside within a local area network (LAN) which interfaces to a network through a leased line (T1, T3, etc.).

The present invention may be embodied as a method, a system, a device, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code embodied in the storage medium. Any suitable computer-readable storage medium may be utilized, including hard disks, CD, DVD, optical storage devices, magnetic storage devices, USB memory keys, and the like.

Data communication may be accomplished through any suitable communication system, such as, for example, a telephone network, intranet, Internet, LAN, WAN, point of interaction device (point of sale device, personal digital assistant, cellular phone, kiosk, etc.), online communications, off-line communications, wireless communications, a radio dispatch network, and/or the like. Data communication may be accomplished through a combination of data networks. Further, any databases, systems, and/or components of the present invention may comprise any combination of databases or components at a single location or at multiple locations, wherein each database or system may include any of various suitable security features, such as firewalls, access codes, encryption, decryption, compression, decompression, and/or the like. The computing units or other components may be connected with each other by a data network.

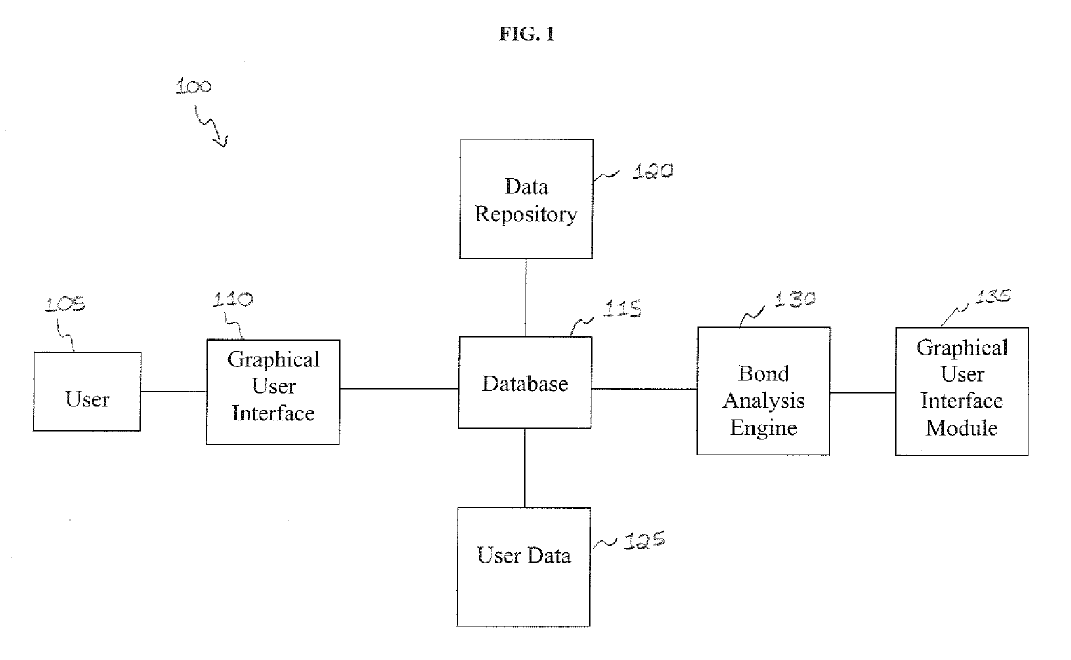

Referring now to FIG. 1, systems and methods for determining the financial status of a bond according to various aspects of the present invention may be representatively illustrated by a bond system 100. In various embodiments, the bond system 100 may be suitably configured for access by a user 105.

The bond system 100 may be configured to determine information characterizing a financial status of a bond as desired by the user 105. The bond may comprise any debt investment security such as where money is loaned to an entity such as a governmental body or business that borrows the money for a preselected period of time with an interest rate payable to the investor.

In one embodiment, the bond may comprise a bond type and a bond rate. In some embodiments the bond rate may comprise as fixed rate bond. The fixed rate bond may comprise a fixed coupon (interest) rate, which is an interest rate that is fixed for the term of the bond and the interest earned on the bond may be paid to the investor at an time such as monthly, semiannually, or annually. The interest rate is known as coupon rate and interest is payable at specified dates before bond maturity. Due to its fixed nature, the fixed rate bond is not susceptible to fluctuations in interest rates, and is therefore viewed as a security that does not possess a significant amount of interest rate risk.

In another embodiment, the bond rate may comprise a variable rate demand bond or floating rate notes (FRNs) bonds. The variable rate demand bond has a floating coupon rate in which the interest rate changes over time according to market conditions. Variable rate demand bond are bonds that have a variable coupon, equal to a money market reference rate, like LIBOR or federal funds rate, plus a quoted spread (a.k.a. quoted margin). The spread is a rate that remains constant. Almost all FRNs have quarterly coupons, i.e. they pay out interest every three months. At the beginning, of each coupon period, the coupon is calculated by taking the fixing of the reference rate for that day and adding the spread.

The bond system 100 may be customized to determine the information characterizing the financial status of the bond based on information relating to the bond entered by the user 105. For example, the user 105 may identify the bond type as a corporate bond, which may comprise a bond issued by a utility company, a financial institution, a consumer goods company, a foreign bond issuer, or any other suitable institution. In one embodiment, the user 105 may identify the bond type as a government bond, which may comprise a bond issued by a municipality, the federal government's treasury, a governmental agency, or any other type of institution.

In various embodiments of the present invention, the information characterizing the financial status of a bond that may be determined by the bond system 100 may comprise a cost basis of the bond. The cost basis of the bond may change and/or be calculated according to a variety of factors, such as an original issue discount value (OID value) of the bond, a gain or loss in value of the bond when it is sold, a bond discount, and/or a bond premium, as will be discussed in detail below.

The user 105 may comprise an individual, such as a bondholder or a bond issuer. The user 105 may also comprise any suitable person, company, governmental agency, and/or institution that may buy, sell, trade, value, and/or provide financial advice. For example, the user 105 may comprise an investment broker and/or dealer, a mutual fund company, a tax professional, a government department such as the IRS, and/or a non-profit institution such as a university and/or charity.

In one embodiment, according to various aspects of the present invention, the user 105 may own, transact business, evaluate and/or otherwise interact with the bond. The user 105 may access a graphical user interface 110, such as through a personal computer or an online website.

The bond system 100 may comprise the graphical user interface 110, such as a website interface, for access by the user 105. The graphical user interface 110 may comprise any suitable system for communicating, accessing, retrieving, updating, exchanging information, organizing information, and/or managing information such as, for example, by data collection, encryption, acquisition, storage, and/or dissemination. In one embodiment, the graphical user interface 110 may comprise a website interface, such as for a web server. For example, the web server may comprise a Microsoft® Windows® Internet Information Services (IIS) Web Server.

The bond system 100 may also comprise a database 115 communicatively coupled to the graphical user interface 110. The database 115 may store information entered by the user 105, such as to save the information for the user 105 to access at a later date. The database 115 may also comprise other stored information, such as information retrieved from a data repository 120 by the graphical user interface 110.

In various embodiments, according to various aspects of the present invention, the database 115 may be accessed by the user 105 through the graphical user interface 110. The database 115 may store bond data composing information about the bond. In various embodiments, the user 105 may enter user data 125 into the database 115 for storage and/or analysis. The user data 125 may comprise any information that may allow the bond system 100 to determine the desired financial characteristics of a bond. For example, the user data 125 may comprise information that identities the bond and/or supports the calculation of the cost basis, price, and/or the yield to maturity of the bond. In one embodiment, the user 105 may enter a bond identifier such as an International Securities Identification No. (ISIN), ticker symbol, purchase date, purchase price, quantity of bonds purchased, sale date, and/or interest information such as an interest rate and/or interest payment frequency.

In various embodiments, according to various aspects of the present invention, the database 115 may retrieve information from various sources. The information may comprise bond data that may or may not be provided by the user 105. For example, as stated above, bond data may comprise user data 125 stored in the database 115. Additionally, the graphical user interface 110 may access any suitable data repository 120 that may contain bond data. In one embodiment, the data repository 120 may be an electronic repository that may be accessible through the Internet. For example, the data repository 120 may retrieve bond data from the IRS tax database, stock exchanges, and/or investment information services such as Markit™. In one embodiment, bond data may comprise International Securities Identification Nos. (ISIN), ticker symbols, bond maturity dates, bond purchase prices, bond par values, coupon interest rates, current bond values, and/or interest payment information such as interest payment frequency.

In various embodiments, according to various aspects of the present invention, the database 115 may comprise tables, such as calculation tables. Calculation tables may organize information in the database 115 for analysis by the bond system 100. In one embodiment, an OID table may receive and store user data 125 and/or information from the database 115. In one embodiment, an OID table may receive and store user data 125 and/or information from the data repository 120. In another embodiment, the database 115 and/or data repository 120 may comprise more than one OID table comprising multiple OID values. The OID table may receive information such as, for example, the interest rate per payment, required periodic interest rate, coupon interest rate, semi annual coupon payment, number of periods (payments), maturity value (par), payment frequency per year, term of the bond, date of purchase, date of issuance, and/or date of maturity.

In various embodiments, according to various aspects of the present invention, the bond system 100 may comprise a bond analysis engine 130. The bond analysis engine 130 may use information in the database 115 to calculate a cost basis. In one embodiment, the bond analysis engine 130 may use the data organized in the database comprising OID tables to calculate the cost basis of the bond. In one embodiment, the bond analysis engine 130 may use the data organized in the OID tables in combination with user data 125 to calculate the cost basis of the bond. In one embodiment, the bond analysis engine 130 may be communicatively coupled to the database 115 and/or the graphical user interface 110 to perform the calculation and display the cost basis of the bond for viewing by the user 105.

The OID tables may comprise the OID value of the bond, which may be the discount of the bond from par value (the face value of the bond) at the time the bond is issued and represents the difference between the stated redemption price of the bond at maturity and the issue price. In one embodiment, the interest rate yield may be higher than the stated face rate, such as due to a change in the performance of a company issuing the bond or an increase in the interest rate of the bond after the bond offering documents have been completed. In one embodiment, purchase of the bond at any time after the original issue date may give rise to the need for calculating the OID value on the date of purchase and comparing the OID value to the purchase price that was actually paid for the bond. Amortization of the OID value may be added to the purchase price to result in an adjusted purchase price. A market discount may then be subtracted or a market premium may be added to the adjusted purchase price to calculate the cost basis of the bond.

OID values are based on when the bonds were issued. In one embodiment, the OID value is based on a bond comprising a corporate debt instrument issued after 1954 and before May 28, 1969, and government debt instruments issued after 1954 and before Jul. 2, 1982. In one embodiment, the OID value is based an a bond comprising a corporate debt instrument issued after May 27, 1969, and before Jul. 2, 1982. In one embodiment, the OID value is based on a bond comprising a debt instrument issued after Jul. 1, 1982, and before 1985. In one embodiment, the OID value is based on a bond comprising a debt instrument issued after 1984 (other than debt instruments comprising, a contingent payment debt instruments issued after Aug. 12, 1996 and an inflation-indexed debt instruments (including Treasury inflation-protected securities) issued after Jan. 5, 1997). In one embodiment, the OID value is based on a bond comprising an OID on stripped bonds and coupons.

In an exemplary calculation of the OID value by the bond system 100, the OID value may be calculated for a bond having a stated interest rate of 5% with a required yield of 6% when the bond is offered to the public. Therefore, if the bond. has a par value of $1000, then the yield according to the stated interest rate of 5% would be a $50 yield per year. However, due to the required yield of 6%, the yield would be $60 per year. The cash $50 may be divided by the required yield rate of 0.06=$833.33. The OID value is then the difference of $1000−$833.33=$166.67. In one embodiment, the OID value may not be calculated since the OID value is known from the price in the market place on the first date of the sale. In another embodiment, the OID value may be amortized in accordance with a requirement by the U.S. Internal Revenue Service.

The market premium may comprise a purchase price of the bond for an amount greater than the OID value of the bond. In an exemplary embodiment, the market premium may be amortized by multiplying the daily OID amount by the premium paid over the face value of the bond (also referred to as the “acquisition premium”) which has been divided by the remaining OID after the purchase date of the bond (daily OID amount×Acquisition Premium/Remaining OLD after purchase date). For example, the thee value of the bond may be $990 with a market premium price of S941.90. The difference of the face value of the bond and the market premium may therefore be $48.60, where the OID value at purchase was $1000−$941.90=$58.10.

The market discount may comprise a purchase price of the bond for an amount less than the OID value of the bond.

In various embodiments, the bond analysis engine 130 may utilize the information in the database 115 to determine the financial status of the bond. For example,in various embodiments, the bond analysis engine 130 may utilize the OID tables comprising the OID values to calculate the financial status of the bond, which may comprise a market premium, market discount, gains, losses, yield to maturity, compounded interest, accrued interest, current yield, taxable interest income, cost basis, annualized yield, yield to call, and/or effective annual interest rates. In one embodiment, the bond analysis engine 130 may utilize the OID tables to calculate the cost basis of the bond. In various embodiments, the bond analysis engine 130 may utilize the user data 125 in combination with the OID values to calculate the cost basis of the bond.

In various embodiments, the bond analysis engine 130 may calculate the market discount on the bond using an OID table populated with the relevant information in the database 115. For example, the OID table may be populated with information such as the face value (par value) of the bond and the current market price of the bond. In one embodiment, the market discount may be determined from the difference between the thee value of the bond and the current market price that is below the face value, in addition to any OID value. For example, current bond prices may fall when interest rates rise. Thus, a bond with an OID value may be sold at a discount in that the bond may have been a zero coupon bond or the stated interest rate was lower than the market rate at the time of issuance. The OID value may comprise a discount below face value at the time the bond is issued and the OID value may be calculated from the difference between the stated redemption price at maturity and the bond's original issue price.

In various embodiments, the bond analysis engine 130 may calculate the market premium on the bond using the information stored in and/or retrieved by the database 115. The market premium may comprise a premium paid above the face value of a bond, such as when the price of a bond increases due to a drop in interest rates. In one embodiment, the premium may be amortized over the life of the bond. Such amortization may offset the tax implications of interest earned on the bond. For example, the cost basis of the bond may be reduced by the amount of premium amortized each year.

In various embodiments, the bond analysis engine 130 may calculate the cost basis of the bond. The cost basis of the bond may comprise the purchase price of the bond adjusted for any market discount or market premiums paid for the bond. A bond discount may comprise the amount that the market price of a bond is lowered below its par value. For example, if a bond is being sold at 98% of its face value, then the bond discount is 2%. In one embodiment, the bond analysis engine 130 may calculate the bond discount using a straight line method in which the cost basis is adjusted by determining the difference of the par value of the bond on the date of purchase and its current value divided by the number of months to maturity.

In various embodiments, the bond analysis engine 130 may calculate the loss or gain of value of the bond, such as for tax preparation and/or financial planning purposes. In one embodiment, the bond analysis engine may determine the cost basis of the bond, which may be adjusted for bond premiums, discounts, and/or amortization of premiums, discounts, and/or interest payments. The calculated adjusted cost basis of the bond may then be compared to the amount the bond sold for (or a projected sale price) to determine whether the sale of the bond resulted in a gain or loss in value.

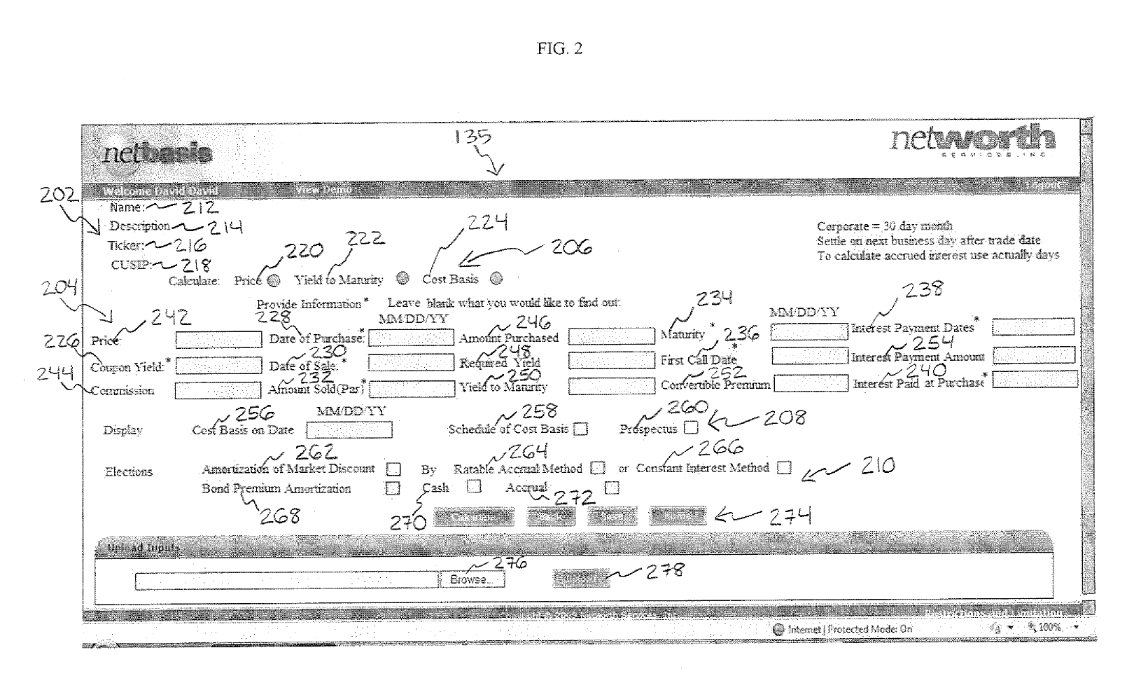

In various embodiments, the bond analysis engine 130 may utilize the user data 125 to calculate the cost basis of the bond. Referring to FIGS. 1 and 2, the bond system 100 may comprise a graphical user interface module 135 for the user 105 to enter user data 125 and/or for the bond system 100 to calculate the cost basis determined by the bond analysis engine 130. The graphical user interface module 135 may be communicatively linked to the database 115 and the graphical user interface 110. The graphical user interface module 135 may comprise a bond identification portion 202, a calculation option portion 206, a data only portion 204, a display portion 208, an election portion 210, and/or an execution action portion 274.

In various embodiments, according to various aspects of the present invention, the database 115 may retrieve and enter information from the data repository 120 and/or the user 105 may enter user data 125 into the bond identification portion 202 of the graphical user interface module 135. The bond identification portion 202 may comprise information identifying the bond such as a name of the bond 212, a description of the and 214, such as the type of bond, ticker symbol 216, and/or a Committee on Uniform Securities Identification Procedures (CUSIP) number of the bond 218 (or the CUSIP International Numbering System Number (CINS) used for foreign securities). In one embodiment, the database 115 may store a directory of bond names 212, ticker symbols 216, and/or CUSIP numbers 218 for the user 105 to select.

Once the user 105 has identified the bond, the graphical user interface module 135 may allow the user 105 to select one or more calculations for execution by the bond analysis engine 130 by using the calculation option portion 206. For example, the calculation option portion 206 ma provide the user 105 with a choice of at least one of a bond price 220, a yield to maturity 222, and/or a cost basis 224 that the user 105 may select.

The user 105 may enter user data 125 into the graphical user interface module 135 utilizing the data entry portion 204. The data entry portion 204 may comprise input windows where the user 105 may enter user data 125 and output windows that may be populated by the bond system 100. In one embodiment, the data entry portion 204 may comprise input windows for data entry that may be used by the bond analysis engine 130 to perform the various calculations selected by the user 105 in the calculation option portion 206. For example, the bond analysis engine 130 may utilize the information entered in the data entry portion 204, such as the bond's coupon yield 226, date of purchase 228, date of sale 230, amount sold at par 232, a date of maturity 234, a first call date 236, an interest payment dates 238, and/or an interest paid at purchase 240. The bond's coupon yield 226 may comprise the interest paid by the issuer at the rate and frequency stated on the bond when it was issued. The bond's date of maturity 234 may comprise the date that the amount of the bond becomes due to be repaid to the investor and interest payments by the issuer stop. The first call date 236 may comprise the date the issuer redeemed the bond prior to maturity.

In various embodiments, the data entry portion 204 may comprise output windows that may be left blank if the user wishes for the bond system 100 to populate those spaces, such as by retrieving the information from the data repository 120 and/or submitting the inquiry to the bond analysis engine 130 for calculation. For example, a price paid for the bond 242, a commission paid for the transaction 244, an amount of bonds purchased 246, a required yield 248, a yield to maturity 250, a convertible premium 252, and/or an interest payment amount 254 may be populated or left blank to be determined by the bond system 100. The required yield 248 may comprise the rate of return that the bond will be issued at that may be set by the market. The yield to maturity 250 may comprise the return on the bond that is anticipated if the bond is held until its maturity date. The convertible premium 252 may comprise the premium value that a convertible bond may be redeemed at by the bondholder. The convertible bond may comprise a type of bond that may be convened into a portion of the issuer's equity, such as stock in a company.

In various embodiments, the display portion 208 may provide options for the user 105 to select further desired information. For example, the user 105 may desire to have the cost basis of the bond determined on a specific date 256. In one embodiment, the user 105 may select that the bond system 100 display a schedule of the cost basis 258. The schedule of the cost basis 258 may comprise a periodic listing showing the amortization of the bond discount with interest payments over time, such as until the bond maturity date. In another embodiment, the user 105 may select a display of a prospectus 260. The prospectus 260 may comprise information such as the number of bonds issued, the precise offering price, the type of bond, risks to the value of the bond such as changing issuer credit, interest rate risk, and/or prepayment risks (issuer call).

In various embodiments, the graphical user interface module 135 may comprise an election portion 210. The election portion 210 may provide options that the user 105 may select to be considered in the calculations performed by the bond analysis engine 130. For example, the user 105 ma elect the amortization of the market discount 262 where the discount is amortized to interest expense over the term of the bond. The amortization may be determined by a ratable accrual method 264 or a constant interest method 266 of accounting.

In various embodiments, the ratable accrual method 264 may comprise determining the dates and amounts of interest income and may be used to evaluate the accrued market discount of the discount bond. In one embodiment, the ratable accrual method 264 of amortizing the market discount may comprise dividing the market discount by the number of days of the bond's maturity date minus the purchase date, multiplied by the number of days the bondholder actually held the bond. For example, when a $10,000 bond is purchased at a discount for $8,000 with 300 days to maturity is sold 150 days later for $9,500, the interest income would be calculated by multiplying the portion of the days held by the increase in value: 150/300=0.5. $10,000−$8,000=$2,000. 0.5×$2,000=$1,000 interest income.

In various embodiments, the constant interest method 266 may comprise determining the accrual of bond discounts. For example, the constant interest method 266 may comprise multiplying the adjusted cost basis by the yield at issuance and subtracting the coupon interest.

Once the user 105 has entered the necessary data into the graphical user interface module 135, the user 105 may select an execution action 274. In one embodiment, the execution action 274 may comprise selecting the calculate button to prompt the bond analysis engine 130 to perform the desired calculations.

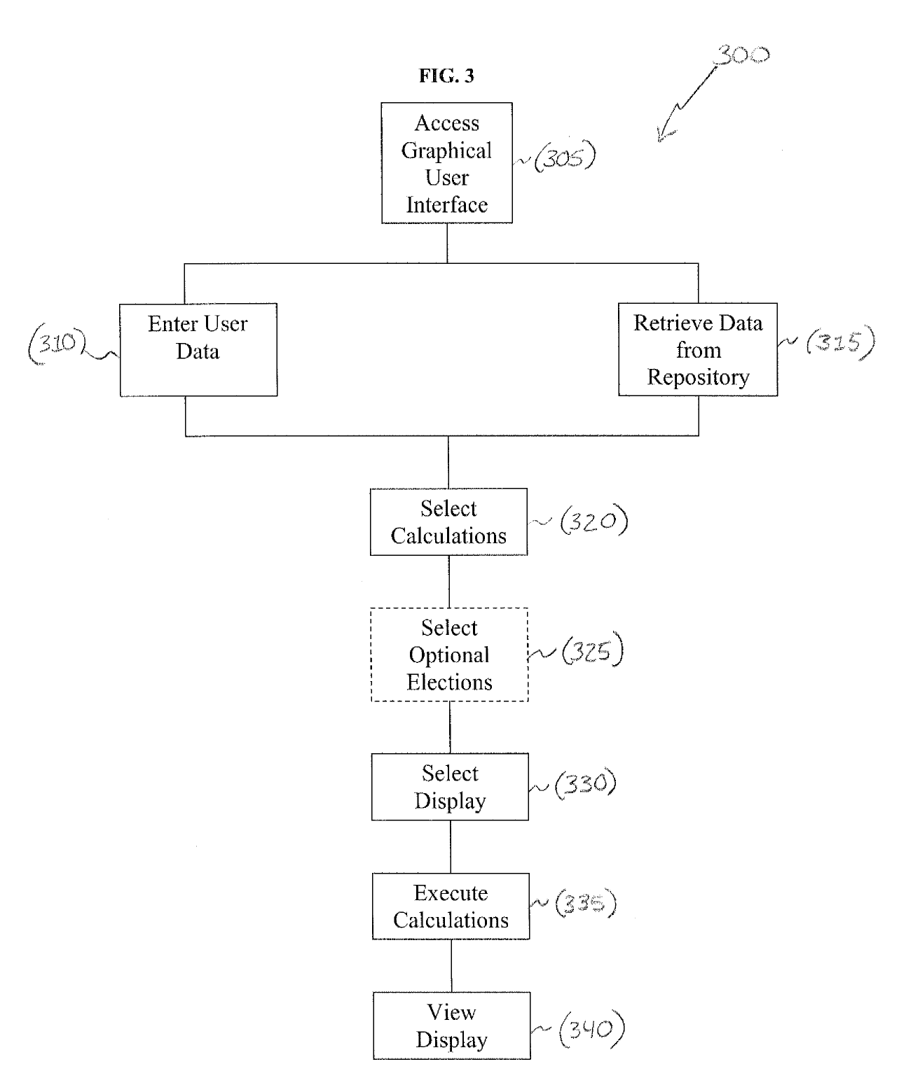

Referring to FIG. 3, a method of operation (300) according to various aspects of the present invention may comprise the user 105 accessing a graphical user interface 110 (305). The user 105 may enter the user data 125 into a graphical user interface module 135 (310). The graphical user interface 110 may be communicatively linked to the database 115. The database 115 may obtain data from a data repository 120 (315). For example, the data from the data repository 120 or the user data 125 may be entered into the bond identification portion 202 and/or the data entry portion 204 of the graphical user interface module 135.

The user may select a calculation option 210 in the graphical user interface module 135 (320). For example, the user 105 may select that the bond analysis engine 130 calculate the price of the bond 220, the yield to maturity 222, and/or the cost basis 224. Optionally, the bond analysis engine 130 may utilize OID tables to calculate the price of the bond 220, the yield to maturity 222, and/or the cost basis 224.

The user may select elections characterizing the bond, such as in the election portion 210 (325). In one embodiment, the user 105 may choose elections that ma affect the outcome of the calculations performed by the bond analysis engine 130. For example, the user 105 may elect the amortization of the market discount 262 or bond premium 268. In some embodiments, the user 105 may elect that the amortization of the market discount 262 be calculated by the ratable accrual method 264 or the constant interest method 266. In another embodiment, the user 105 may elect the amortization of the bond premium 268. The amortization of the bond premium 268 may reflect the amortization of the premium over the life of the bond, which may be used to offset the taxable interest income from the bond. In one embodiment, the user 105 may further elect for the amortization of the bond premium 268 to be in cash 270. In another embodiment, the user 105 may elect for the amortization of the bond premium 268 to include the accrual of interest 272.

The user may optionally select a type of display for the bond system 100 to provide m the display portion 208 (330). For example, in various embodiments the user 105 may select the cost basis of the bond determined on a specific date 256 and/or the user 105 may request that the bond system 100 provide a schedule of the cost basis 258 and/or the bond prospectus 260.

The user may instruct the bond system 100 to execute the desired calculations selected in the calculation option portion 206 of the graphical user interface module 135, by selecting an execution action 274 (335). For example, the bond analysis engine 130 may calculate the cost basis indicated by the user 105 when the user selects the calculate button.

The user may view the display produced by the bond system 100 (340). For example, in one embodiment, the user 105 may view numbers populated by the bond system 100 that were left blank by the user 105 in the data entry portion 204 of the graphical user interface module 135. In some embodiments, the user 105 may also view the displays produced by the bond system 100 such as the displays selected by the user 105 in the display portion 208. For example, the user 105 may view the displays of the cost basis on a specific date, the schedule of the cost basis, and/or the prospectus.

The invention has been described with reference to specific exemplary embodiments. Various modifications and changes may be made, however, without departing from the scope of the present invention as set forth. The description and figures are to be regarded in an illustrative manner, rather than a restrictive one and all such modifications are intended to be included within the scope of the present invention. Accordingly, the scope of the invention should be determined by the generic embodiments described and their legal equivalents rather than by merely the specific examples described above. For example, the steps recited in any method or process embodiment may be executed in any appropriate order and are not limited to the explicit order presented in the specific examples. Additionally, the components and/or elements recited in any system embodiment may be combined in a variety of permutations to produce substantially the same result as the present invention and are accordingly not limited to the specific configuration recited in the specific examples.

Benefits, other advantages and solutions to problems have been described above with regard to particular embodiments. Any benefit, advantage, solution to problems or any element that may cause any particular benefit, advantage or solution to occur or to become more pronounced, however, is not to be construed as a critical, required or essential features or components.

The terms “comprises”, “comprising”, or any variation thereof, are intended to reference a non-exclusive inclusion, such that a process, method, article, composition, system, or apparatus that comprises a list of elements does not include only those elements recited, but may also include other elements not expressly listed or inherent to such process, method, article, composition, system, or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

The present invention has been described above with reference to an exemplary embodiment. However, changes and modifications may be made to the exemplary embodiment without departing from the scope of the present invention. These and other changes or modifications are intended to be included within the scope of the present invention.

1. A system for determining the financial status of a bond, comprising:
a graphical user interface configured to receive information associated with the bond from a user, wherein the information associated with the bond comprises at least one of bond data and a bond identifier;
a database communicatively linked to the graphical user interface and configured to:
store the information associated, with the bond; and
retrieve the information associated with the bond from a data repository;
a bond analysis engine communicatively linked to the database and configured to calculate a cost basis.

2. The system for determining the financial status of a bond according to claim 1, further comprising a display configured to present the cost basis.

3. The system for determining the financial status of a bond according to claim 1, wherein the bond data comprises at least one of a bond maturity date, a bond purchase price, a bond par value, a coupon interest rate, a current bond value, and an interest payment frequency.

4. The system for determining the financial status of a bond according to claim 1, wherein the bond identifier comprises at least one of a bond name, a bond description, an International Securities Identification Number (ISIN), a ticker symbol, a purchase date, a purchase price, a quantity of bonds purchased, a sale date, an interest rate, and interest payment frequency.

5. The system for determining the financial status of a bond according to claim 1, wherein the database comprises an original issue discount table configured to receive and store the information associated with the bond, wherein the bond analysis engine calculates the cost basis using information associated with the bond that is stored in the original issue discount table.

6. The system for determining the financial status of a bond according to claim 1, wherein the cost basis comprises at least one of a market premium of the bond, a market discount of the bond, a cost basis of the bond, an adjusted cost basis of the bond, a loss of bond value, and a gain of bond value.

7. A computer-implemented method for determining the financial status of a bond, comprising:
at least one of inputting and retrieving information associated with the bond, wherein the information associated with the bond comprises at least one of bond data and a bond identifier; and
calculating a cost basis based on the information associated with the bond.

8. The computer-implemented method for determining the financial status of a bond according to claim 7, further comprising displaying the cost basis to the user.

9. The computer-implemented method for determining the financial status of a bond according to claim 7, wherein the bond data comprises at least one of a bond maturity date, a bond purchase price, a bond par value, a coupon interest rate, a current bond value, and an interest payment frequency.

10. The computer-implemented method for determining the financial status of a bond according to claim 7, wherein the bond identifier comprises at least one of a bond name, a bond description, an International Securities Identification Number (ISIN), a ticker symbol, a purchase date, a purchase price, a quantity of bonds purchased, a sale date, an interest rate, and interest payment frequency.

11. The computer-implemented method for determining the financial status of a bond according to claim 7, wherein the information associated with the bond is entered and stored in an original issue discount table.

12. The computer-implemented method for determining the financial status of a bond according to claim 9, wherein a bond analysis engine calculates the cost basis using the information associated with the bond that is stored in the original issue discount table.

13. The computer-implemented method for determining the financial status of a bond according to claim 7, wherein the cost basis comprises at least one of a market premium of the bond, a market discount of the bond, a cost basis of the bond, an adjusted cost basis of the bond, a loss of bond value, and a gain of bond value.
